(19) United States
(12) Patent Application Publication
(10) Pub. No.: US 2013/0026189 A1
(43) Pub. Date: Jan. 31, 2013

(54) DETACHABLE MEASURING AND DISPENSING DEVICE FOR PORTABLE CONTAINERS

(71) Applicants: CJ KNAPP, Salt Lake City, UT (US); CHRISTOPHER J. KNAPP, Murray, UT (US)

(72) Inventors: CJ KNAPP, Salt Lake City, UT (US); CHRISTOPHER J. KNAPP, Murray, UT (US)

(21) Appl. No.: 13/275,505

(22) Filed: Oct. 18, 2011

Related U.S. Application Data
(60) Provisional application No. 61/511,194, filed on Jul. 25, 2011.

(51) Int. Cl. B67D 7/56; G01F 11/26

(52) U.S. Cl. 222/158; 222/454

(57) ABSTRACT

A measuring and dispensing device for portable handheld containers is disclosed. The measuring device allows a user to measure and dispense contents from a handheld container with one hand, while using a second hand for managing other tasks. The measuring device comprises, in one embodiment, a body elongated along a lateral axis affixed to a conduit elongated along a longitudinal axis, wherein the conduit is detachably affixed to the opening of a bottle, jar, or similar container holding baby food, milk, granule materials, powders, oil, chemicals, aggregate, or other edible or non-edible contents. The contents are poured through the conduit into a receptacle portion of the body designed to receive only a predetermined volume of the contents, which contents are subsequently dispensed into a target container using only the motion of a user's wrist.

### CROSS-REFERENCES TO RELATED APPLICATION

This application claims priority to U.S. Provisional Patent Application No. 61/511,194 entitled “Measuring and Dispensing Device,” filed Jul. 25, 2011 for C J Knapp et al., which is incorporated herein by reference.

### BACKGROUND OF THE INVENTION

1. Field of the Invention

This invention relates to measuring devices, and more particularly relates to a measuring and dispensing device for portable, handheld containers.

1. Description of the Related Art

Apparatii which measure and dispense fluids, powders, and granulated materials are needed in residential, industrial and commercial settings; for cooking, food preparation (e.g. measuring powdered milk or baby formula), combining chemicals, adding oil to machinery, and the like. Numerous and varied types of handheld devices are available which serve this purpose, including funnels, and teaspoons; none of which remain affixed to a portable source container or which can be conveniently used with a single hand. Many of the devices in the prior art can be overfilled inadvertently. These apparatii fail to fulfill a need on the part of parents, mechanics, chemists, and cooks to measure and dispense container contents with a single hand while holding babies, machines, cooking utensils, and/or the like with another.

Parents often must feed babies in sleep deprived circumstances, or when traveling, while searching for incidental measuring and dispensing devices for baby food, cereal, or powdered milk—or engaging in a complex series of steps—is inconvenient.

Several patents have been awarded to concepts that assist in the measuring and/or dispensing of granular material, or powder; in particular, milk powder or baby formula. Many of these various incarnations of the prior art provide benefit in some circumstances, but not in others. Some dispensing devices known in the art are primarily ornamental. Others comprise compartments for warehousing pre-measured amounts of granulated material or powder. Others are easily overfilled, or not reliable in the volume of contents they dispense.

There exists a need in the art for a simple and effective apparatus that allows a predetermined volume of fluids, powders and/or other granulated materials to be measured and dispensed easily from a source container using only the motion of a user's wrist, without using incidental and cumbersome measuring devices, and without investment of thought in a series of steps while fatigued.

### SUMMARY OF THE INVENTION

From the foregoing discussion, it should be apparent that a need exists for a detachable measuring and dispensing device for handheld containers. Beneficially, such a measuring device would overcome many of the difficulties with prior art by providing a more functional apparatus to consumers and professionals which can be used when fatigued with a single hand.

The present invention has been developed in response to the present state of the art, and in particular, in response to the problems and needs in the art that have not yet been fully solved by currently available apparatii and methods. Accordingly, the present invention has been developed to provide a detachable measuring and dispensing cap for a portable container comprising: a cylindrical body comprising a closed distal end and an open proximal end, the cylindrical body defining a hollow interior cylindrical recess, the cylindrical body defining an aperture disposed between the proximal end and distal end, the aperture penetrating the cylindrical body to the cylindrical recess; a conduit affixed to the exterior of the cylindrical body, the conduit defining a hollow interior passageway, the conduit encircling the hole on the exterior of the cylindrical body such that granulated materials and fluids freely travel between the hollow interior passageway of the conduit and the cylindrical recess; the conduit comprising an open annular base with internal female threading for detachably engaging external male threading on the portable container, such that contents of the portable container, when the portable container is inverted, flow from the portable container, through the hollow interior passageway, into the cylindrical recess, where the contents can be dispensed from the open proximal end by rotating the cap axially.

The cylindrical body may further comprise a receptacle for receiving a predetermined volume of contents, the receptacle disposed between the distal end of the cylindrical body and the aperture.

The receptacle may be transparent such that contents contained in the receptacle can be seen through the cylindrical body. The detachable measuring and dispensing cap may further comprise linear measurement markings for visually quantifying the volume of contents in the cylindrical body.

The detachable measuring and dispensing cap for a portable container, further comprising an end cap detachably affixable to the open proximal end for sealing the open proximal end.

The end cap may be tethered to the cylindrical body. The closed distal end may be closed with a detachable end cap. The detachable measuring and dispensing cap may further comprise one or more receptacles or predetermined volume, the receptacle(s) attachable to the distal end of the cylindrical body in place of the detachable end cap.

The cylindrical body may be between 1 centimeter and 100 centimeters in length and wherein the volume of the cylindrical recess is between 1 cubic centimeter and 200 cubic centimeters. The open proximal end may further comprise a one-way valve for preventing ambient air from flowing into the cylindrical body.

A detachable measuring and dispensing assembly is also disclosed for a handheld container comprising: an elongated, tubular body, elongated along a lateral axis, the body comprising an open proximal end, the body defining a hollow interior channel of between 10 cubic millimeters and 1 cubic meter in volume, the body forming a recess, the recess penetrating the body to the channel; a conduit affixed to the exterior of the cylindrical body, the conduit elongated along a longitudinal axis, the conduit defining a hollow interior passageway, the conduit enclosing the recess on the exterior of the body such that the channel and passageway are interconnected; wherein the conduit comprises an open annular base with means for engaging a handheld container, such that contents of the handheld container, when the handheld container is inverted, flow from the handheld container, through the hollow passageway, into the channel, where the contents can be dispensed from the open proximal end by rotating the assembly axially.

The body may be transparent such that contents contained in the recess are visible through the body. The detachable measuring and dispensing device may further comprise linear measurement markings for visually quantifying the amount of contents in the body.

In some embodiments, the detachable measuring and dispensing device further comprises a cap screwable and detachably affixed to the open proximal end for sealing the open proximal end. The open proximal end may further comprise a valve for preventing ambient air from flowing into the body.

A detachable measuring and dispensing appendage for a handheld container is also disclosed comprising: a T-shaped tubular body, having a hollow interior with an outlet opening, the T-shaped body comprising: a lower member, having an inlet opening, the lower member having means for detachably engaging an outlet opening on the handheld container, the lower member defining a passageway interconnected with the hollow interior of the main body, the member oriented orthogonally to the main body; and a hollow receptacle arm for receiving a predetermined volume of contents from the handheld container, the hollow receptacle arm interconnected with the hollow interior; wherein the outlet opening is formed by an arm of the T-shaped body.

The detachable measuring and dispensing device may further comprise one or more accessories for detachable affixation to the outlet opening from the list consisting of a funnel, a valve, a strainer, and a macerator.

The outlet opening may further comprise a valve for preventing ambient air from flowing into the body. The detachable measuring and dispensing device may further comprise a cap detachably affixable to the outlet opening for sealing the open outlet.

The cap may also be tethered to the main body.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side elevational perspective view of a detachable measuring cap for portable containers in accordance with the present invention;

FIG. 2 is a side elevational perspective view of a detachable measuring cap for portable containers in accordance with the present invention;

FIG. 3 is a side elevational perspective view of a detachable measuring cap for portable containers in accordance with the present invention;

FIG. 4 is a lower-side perspective view of a detachable measuring cap for portable containers in accordance with the present invention;

FIG. 5 is a lower perspective view of a detachable measuring cap for portable containers in accordance with the present invention; and

FIG. 6 is a sectioned side perspective view of a detachable measuring cap for portable containers in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

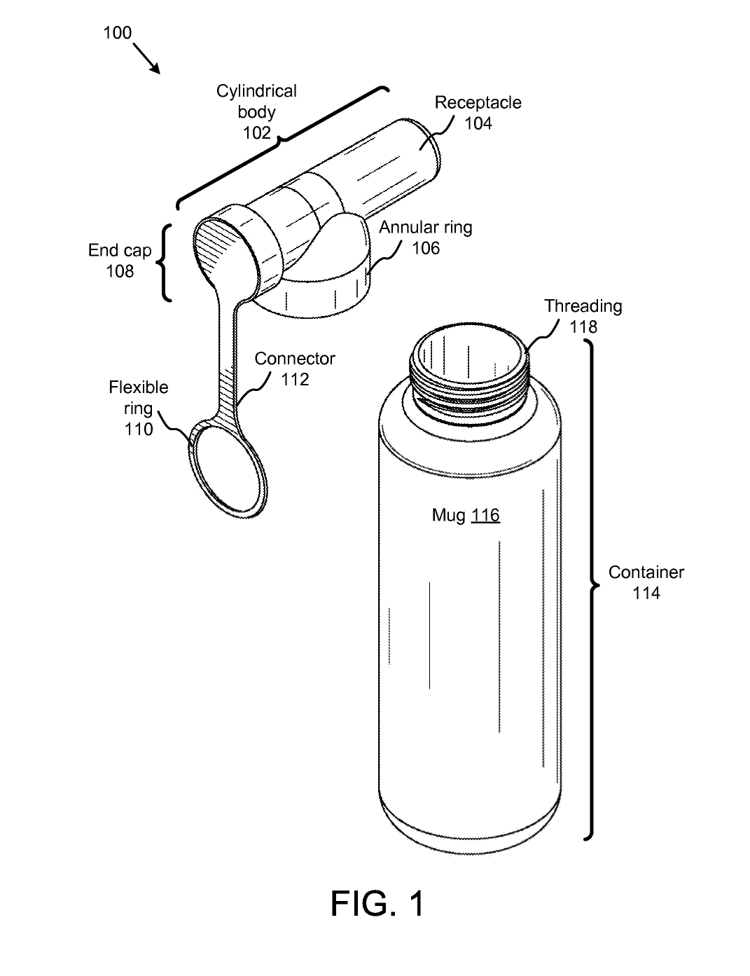

FIG. 1 is a side elevational perspective view of a detachable measuring cap 100 for portable containers in accordance with the present invention. The detachable measuring cap 100 comprises a cylindrical body 102, a receptacle 104, an annular ring 106, an end cap 108, a flexible ring 110, a connector 112, a container 114, a mug 116, and threading 118.

The cylindrical body 102 is fabricated, in the shown embodiment, from one a rigid polymer, metal, alloy, wood, glass, elastomeric, or silastic material. The cylindrical body 102 may fabricated to conform to governmental regulations for food and contact surfaces. In various embodiments of the present invention, the cylindrical body 102 is a test tube, or is test tube-shaped, with a closed distal end for retaining fluids, powder or aggregates before dispensing them by inverting the cylindrical body 102. The cylindrical body may be tubular, toroidal, cubic, conical, or any other Euclidean shape.

The cylindrical body 102 comprises a distal end, which is closed, capped or sealed; and comprises a proximal end, which is open for dispensing contents from the cylindrical body 102. This open proximal end may also be known as an open outlet.

In various embodiments, the proximal end (e.g. open end) may comprise a valve, such as a one-way check valve, for dispersing contents from the cap 100, but largely preventing ambient air from flowing in and out of the cap 100. By isolating atmospherically the contents from the ambient air, the present invention prevents the contents held in the container 114 from drying out or spoiling.

The cylindrical body 102 may be transparent or translucent. In those embodiments, the cylindrical body 102 may comprise linear measuring lines for visually determining the quantity of contents in the receptacle 104. These linear marking may be printed with ink or paint onto the exterior of the cylindrical body 102, or may comprise engravings or etching into the exterior recess itself.

In various embodiments, one or more accessories may be affixed detachably to the open proximal end of the cylindrical body 102, including a funnel, a strainer, a macerator, a thermometer, a filter, a heater, and the like.

In some embodiments of the present invention, the cylindrical body 102 is tapered as it runs toward the proximal end. In those embodiments, the cylindrical body 102 may serve as a funnel.

In various embodiments, the portion of the cylindrical body 102 resting aft (i.e. toward the distal end) of the intersection of the lower conduit with the cylindrical body 102 constitutes the receptacle 104. This receptacle 104 is used for receiving contents from the container 114, and temporarily holding these contents before dispensing them in accordance with the wishes of a user.

In various embodiments, the receptacle 104 is used for measuring the amount of the contents to be dispensed by volume. The receptacle 104 may be transparent, and may comprise external linear measurement markings for visually quantifying the amount of contents in the receptacle 104.

The proximal end of the cylindrical body 102 is open. In various embodiments, the proximal end is encircled by a lip, or annular ring, for engaging an end cap 108. In various embodiments, the cylindrical body 102 may comprise a plurality of cylinders conjoined at their ends to form the longer cylindrical body 102. These cylindrical component may be permanently or detachably affixed end-to-end with one another to form the cylindrical body 102, or to extend the length of the cylindrical body 102.

End caps 108 are known to those of skill in the art. In various embodiments, the end cap 108 is threaded and screws onto the proximal end. In alternative embodiments, the end cap 108 snaps onto the proximal end, or is sealed against the proximal end using means known to those of skill in the art. The end cap 108 may be affixed to the cylindrical body 102 using the flexible ring 110.

The container 114 may comprise any portable or handheld container containing any edible or non-edible fluid, powder or granular material, such as baby food, milk, Tang®, powdered milk, sugar, salt, oil, and the like (the “contents”). In the shown embodiments, the container 114 is a milk carton 116 comprising powdered milk.

The cap 100 is detachably affixed to the container 114 in place of a cap or lid. In various embodiments, the cap 100 screws onto the container 114 using threading 118. In other embodiments, the cap 100 snaps onto the container 114 using means known to those of skill in the art.

In various embodiments, the flexible ring 110 is threaded over the distal or proximal end of the cap 100, or threaded over the cylindrical body 102 of the cap 100. The end cap 108 is then attached and detached from the cylindrical body 102 where the end cap 108 hangs from the threaded flexible ring 110 (interconnected to the flexible ring 110 via the connector 112).

In various embodiments, the connector 112 may be secured with a pipe clamp or using other means known to those of skill in the art, to the cylindrical body 102. The end cap 108 may be tethered to the cylindrical body 102 using any means known to those of skill in the art.

The contents of the milk carton 116 transferred to the receptacle 104 portion of the cylindrical body 102. In various embodiments, an annular ring 106, which is threaded on its inside, is screwably attached to the neck of the container 114. The cap 100, in the shown embodiment, is T-shaped, and comprises a stem jutting orthogonally from the cylindrical body 102, which stem comprising the annular ring 106. The annular ring 106 exists for engaging the open outlet of the container 114.

In some embodiments, the annular ring 106 may be affixed to a housing, conduit or hollow channel, which hollow channel is affixed to the cylindrical body 102, through which hollow channel the contents flow for temporary storage in the receptacle 104.

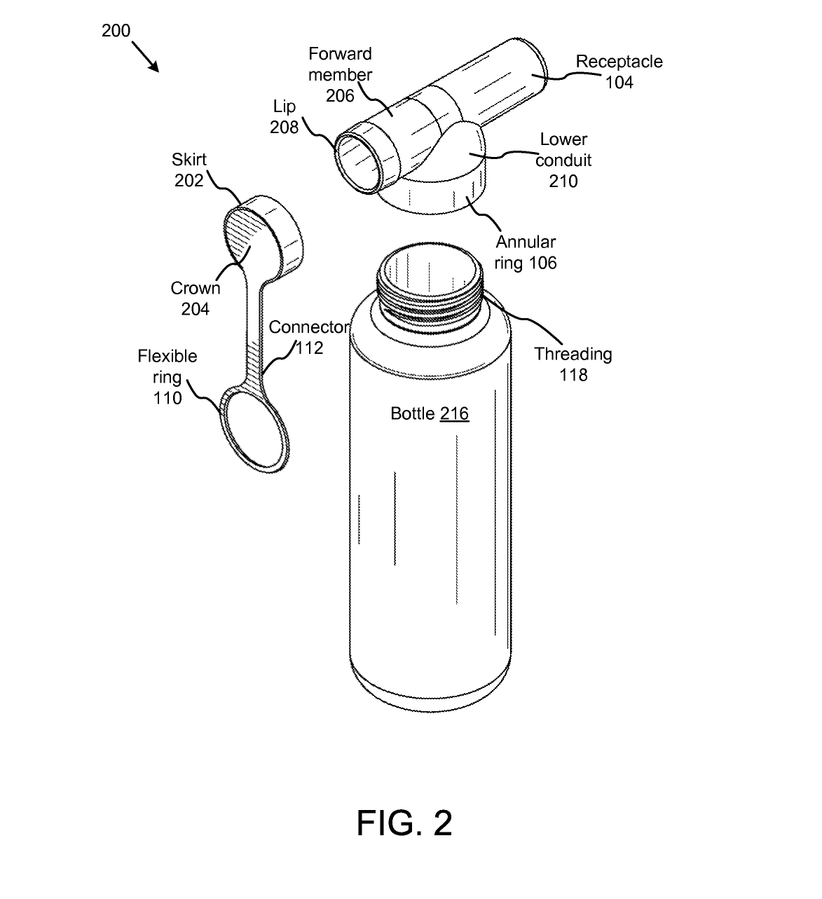

FIG. 2 is a side elevational perspective view of a detachable measuring cap 200 for portable containers in accordance with the present invention. The detachable measuring cap 200 comprises a receptacle 104, an annular ring 106, a flexible ring 110, a connector 112, a skirt 202, a crown 204, a forward member 206, a lip 208, a lower conduit 210, and a bottle 216.

The end cap 108 comprises, in the shown embodiment, a crown 204 for covering the proximal end of the cylindrical body 102, and a skirt 202, for gripping the sides of the proximal end of the cylindrical body 102. In various embodiments, the skirt 202 may be threaded.

The portion of the cylindrical body 102 between the receptacle 104 and the open end (i.e. the proximal end) comprises the forward member 206.

The cylindrical body 102 comprises a lip 208 at its proximal end. The lip 208 may comprise a flange circumscribing the forward member 206 in part. In various embodiments, the lip 208 comprises a ring jutting in cantilevered fashion from the proximal end of the cylindrical body 102 for engaging the end cap 108. The lip 208 may comprise a metal, plastic and/or polymer rim.

In various embodiments, the cylindrical body 102 is affixed to a housing or lower conduit 210. The lower conduit 210, in the preferred embodiment, is fabricated from the same material as the cylindrical body 102.

The lower conduit 210 interconnects the cylindrical body 102 with the container 114. The lower conduit 210 defines a hollow channel, passageway, or recess through which the contents flow from the container 114 to the receptacle 104.

The length of the cylindrical body 102 is orthogonal, in the shown embodiment, to the length of the interior recess of the lower conduit 210. Because the lower conduit 210 is attached to the mid-section of the cylindrical body 102, the cap 200 is cross-shaped, with the length of the cylindrical body 102 being affixed orthogonally to the length of the lower conduit 210.

In the shown embodiment, when the cap 200 is affixed to the container 114, the container 114 can be inverted, allowing the contents to flow into the receptacle 104. Once the desired amount of contents has entered the receptacle 104, the container 114 can be rotated axially around the longitudinal axis of the container 114, allowing the contents to flow through and out the proximal end of the cylindrical body 102 and into a receiving container, such as cup.

The present invention discloses a simple and effective apparatus for measuring and dispensing granular material or powder. Building a measuring device perpendicularly into the lid of the container that warehouses the formula, and an opening opposite and wider than the measuring device, allows the user to dispense the required amount of formula into the receiving container with only one hand, solving the problem of having to measure and dispense granular material or powder with the use of only one hand. The present invention also is effective in sleep deprived circumstances as the powder and measuring device are connected, requiring less thought. The overall small size of the device as well as the fact that there is no need to pre-measure amounts of formula solves the portability issues. The fact that its one piece makes it simple to use and clean, and is also cost effective enough to allow virtually all parents to obtain it.

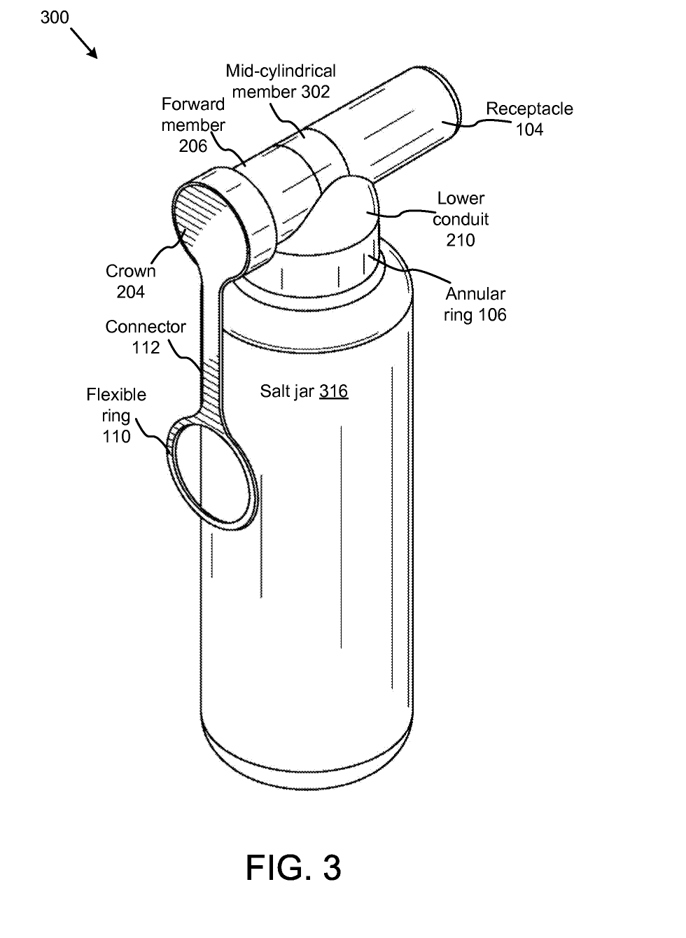

FIG. 3 is a side elevational perspective view of a detachable measuring cap 300 for portable containers in accordance with the present invention. The detachable measuring cap 300 comprises a receptacle 104, an annular ring 106, a flexible ring 110, a crown 204, a forward member 206, a lower conduit 210, and a salt jar 316.

The receptacle 104, annular ring 106, flexible ring 110, crown 204, forward member 206, lower conduit 210, and salt jar 316 are all substantially described above in relation to FIGS. 1-2.

The container 114, in the shown embodiment, comprises a salt shaker 316.

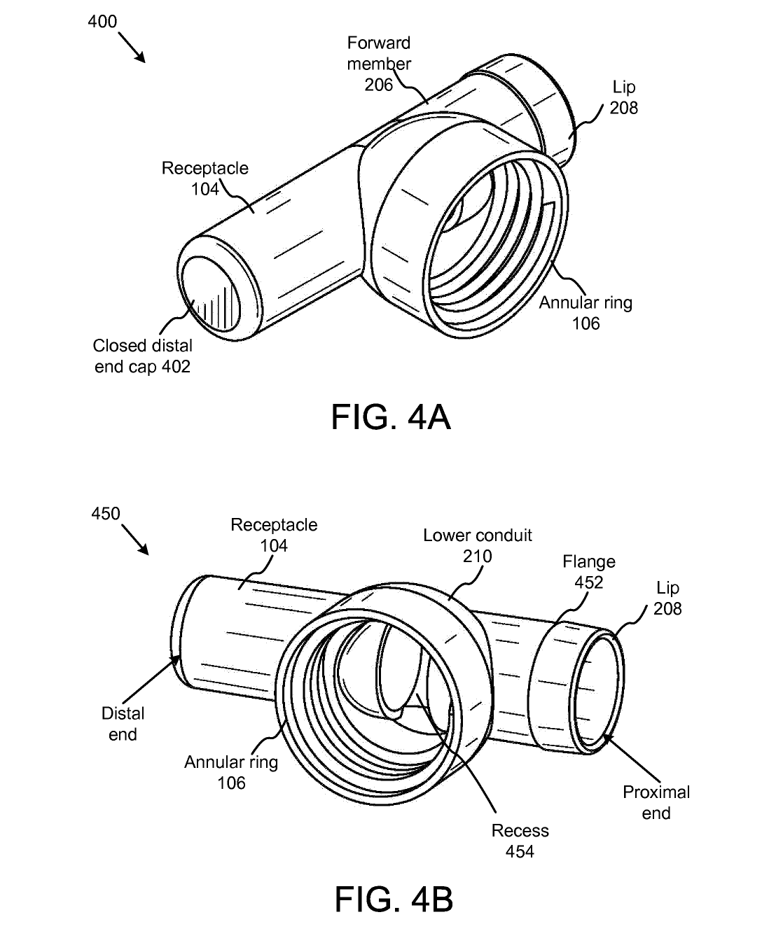

FIG. 4A is a lower-side perspective view of a detachable measuring cap 400 for portable containers in accordance with the present invention. The detachable measuring cap 400 comprises a receptacle 104, an annular ring 106, a forward member 206, a lip 208, and a closed distal end cap 402.

The receptacle 104, annular ring 106, and lip 208 are substantially described above in relation to FIGS. 1-3.

The forward member 206 is the portion of the cylindrical body 102 disposed between the connection point of (1) the cylindrical body 102 with the lower conduit 210, and (2) the proximal end of the cylindrical body 102.

In the shown embodiment, the cap 400 comprises a closed distal end cap 402. In various embodiments, the cylindrical body 102 may be manufactured with a closed distal end using means known to those of skill in the art, such as plastic mold injection or glass blowing. In alternative embodiments, the cylindrical body 102 may comprise a pipe, tube, sleeve or cylinder which is caped with a separately manufactured end cap 402 using adhesives, glues, threading, or via other means known to those of skill in the art.

The lower conduit 210 exists, as shown, to provide means for affixing the cap 400 to the container 114 and to transfer the contents from the container 114 to the receptacle 104. The lower conduit 210 is hollow, and defines a hollow interior recess connected to the interior recess defined by the cylindrical body 102.

FIG. 4B is a lower perspective view of a detachable measuring cap 450 for portable containers in accordance with the present invention. The detachable measuring cap 450 comprises a receptacle 104, an annular ring 106, a lip 208, a lower conduit 210, a flange 452, and a recess 454.

The receptacle 104, annular ring 106, lip 208, and lower conduit 210 are all substantially described above in relation to FIGS. 1-4A.

The flange 452 is the portion of the lip 108 which juts in cantilevered fashion from the cylindrical body 102. In various embodiments, the flange 452 comprises a ring circumscribing the proximal end of the cylindrical body 102. In various embodiments, the flange 452 exists to engage the skirt 202 in lockable fashion. The skirt 202 may grip the flange 452.

As shown from the lower perspective view, the cylindrical body 102 defines a recess 454. This recess exists on the lower portion of the cylindrical body 102, which portion is enclosed by the lower conduit 210. This recess 454 may be formed by boring the cylindrical body after manufacture, or by may be formed during manufacture of the cylindrical body using molds, 3D printing, DMLS (digital metal laser sintering), or other means known to those of skill in the art. The recess 454 may be cut from the cylindrical body 102.

The recess 454 exists to facilitate the passing of contents through the lower conduit 210 to the receptacle 104 from the container 114. Because the recess 454 is cut, bored or defined by only a portion of the lower half of cylindrical body 102, contents in the receptacle 104 may be poured from the cylindrical body 102 by pouring the contents along the upper half of the cylindrical body 102 after inverting or partially inverting the cap 450. With these characteristics, the cap 450 facilitates convenient measuring and dispensing of the contents using only gravity and turns of the user's wrist to effectuate the measurement and disbursement.

The receptacle 104 is designed to limit the amount of contents that can be temporally received by the cylindrical body 102. One novelty of the present design is the means provided of preventing the receptacle 104 from being overfilled, and consequently of preventing a user from carelessly dispensing an excess amount of contents into a target container. Because the receptacle 104, in the shown embodiment, is defined by the portion of the cylindrical body 102 disposed between the distal end cap 402 and the recess 454 (e.g. aperture, hole, cavity, etc.), contents exceeding the volume of the receptacle 104 fall back through the lower conduit 210 into the container 114.

Because the volume of the receptacle 104 is predetermined, the length of the receptacle 104 varies with different embodiments. In some embodiments, the receptacle 104 may comprise telescoping cylindrical members, such that the volume of the receptacle 104 is adjustable. In other embodiments, the end cap 402 is removable, such that detachable receptacles may be affixed to the distal end of the cylindrical body 102, provided users with means of augmented the volume of the receptacle 104 by adding additional cylindrical receptacles to the distal end.

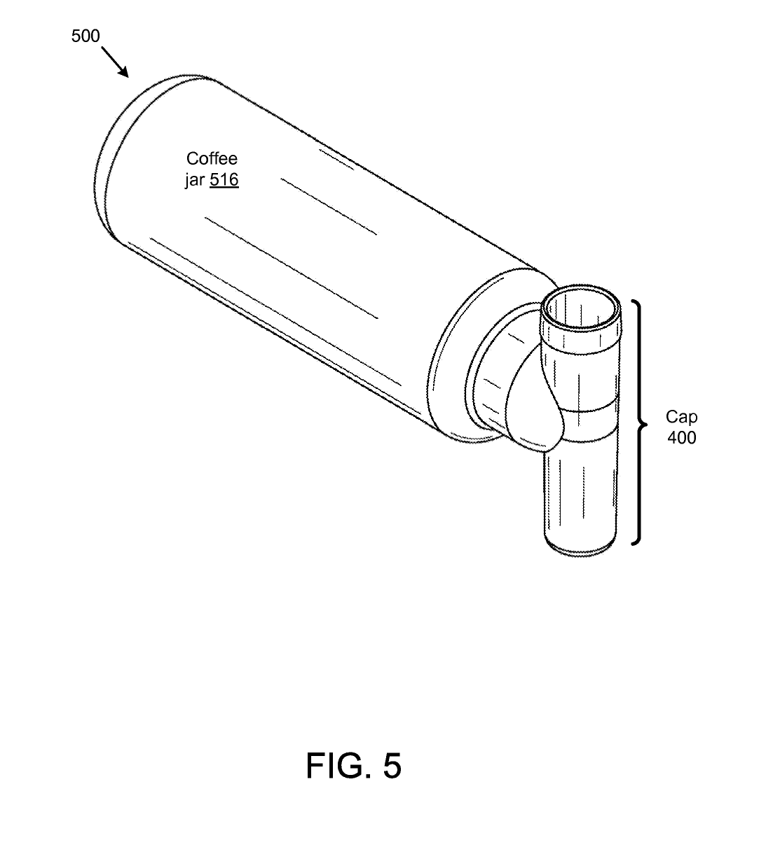

FIG. 5 is a lower perspective view of a detachable measuring cap 500 for portable containers in accordance with the present invention. FIG. 5 exists to show the cap 400 from a different perspective and highlight the fact that the caps 100-400 herein disclosed may be detachably affixed to any portable or handheld container, including a coffee jar 516.

The cap 400 may comprise a T-shaped body. The lower conduit 210 may comprise a stem, which may be elongated across a longitudinal axis of the cap 400. In those embodiments, the cylindrical body 102 forms the top of the T-shaped body, with the receptacle 104 forming a lateral arm in the T-shaped body and the forward member 206 forming the opposing arm of the T-shaped body.

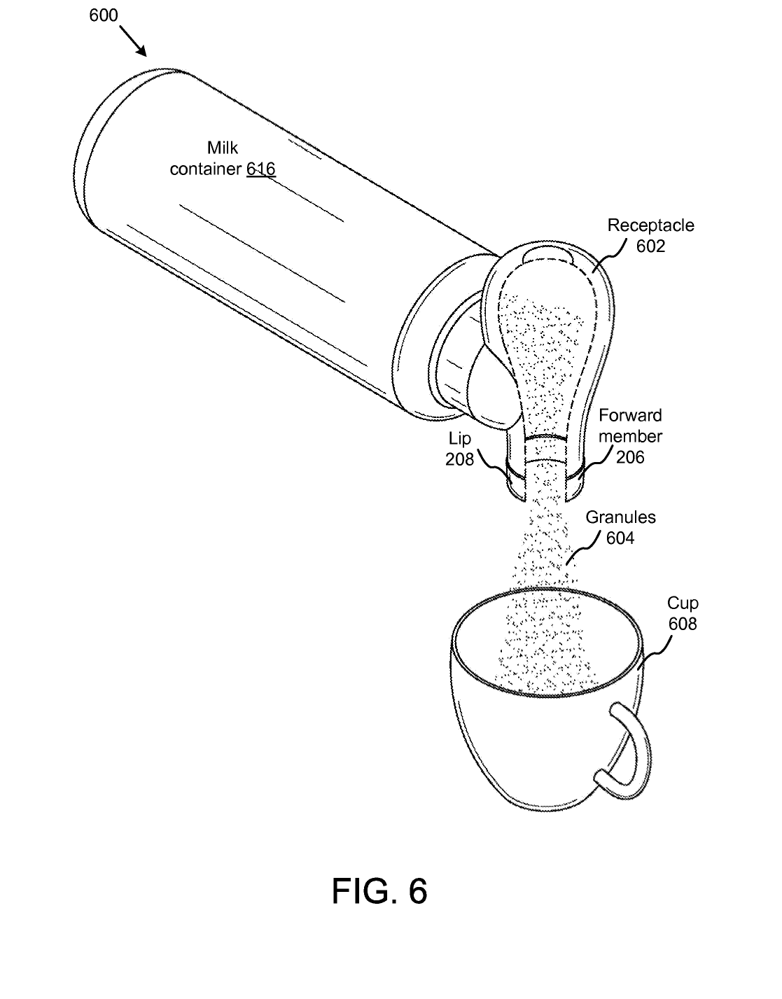

FIG. 6 is a sectioned side perspective view of a detachable measuring cap 600 for portable containers in accordance with the present invention. The detachable measuring cap 600 comprises a forward member 206, a lip 208, a receptacle 602, granules 604, a cup 606, and a milk container 616.

The forward member 206 and lip 208 are substantially described above in relation to FIGS. 1-5.

The receptacle 602, like the receptacle 104, exists to house, or temporarily contain, the contents (e.g. granules 604) before disbursement into the cup 608. Unlike the receptacle 104, the receptacle 602 may shaped in other than cylindrical fashion. In the shown embodiment, the receptacle 602 is bulbous, or egg-shaped. The receptacle 602, in the shown embodiment, may be affixed to the mid-section or forward member 206 (in place of the receptacle 104). In other embodiments, the receptacle 602 may be affixed to the distal end of the cylindrical body 102 aft of the receptacle 104 to augment the amount of content which can be stored by the receptacle 104 and/or the cylindrical body 102.

In these embodiments, the receptacle 602 may affixed to the receptacle 104 in place of the distal end cap. In these embodiments, a plurality of receptacles 602, of different predetermined volumes, may be detachably affixable to the receptacle 104 such that a user has the option of setting, or configuring, the volume of contents to be measured and dispersed by the cap 400.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A detachable measuring and dispensing cap for a portable container comprising:
a cylindrical body comprising a closed distal end and an open proximal end, the cylindrical body defining a hollow interior cylindrical recess, the cylindrical body defining an aperture disposed between the proximal end and distal end, the aperture penetrating the cylindrical body to the cylindrical recess;
a conduit affixed to the exterior of the cylindrical body, the conduit defining a hollow interior passageway, the conduit encircling the aperture on the exterior of the cylindrical body such that granulated materials and fluids freely travel between the hollow interior passageway of the conduit and the cylindrical recess;
the conduit comprising an open annular base with internal female threading for detachably engaging external male threading on the portable container, such that contents of the portable container, when the portable container is inverted, flow from the portable container, through the hollow interior passageway, into the cylindrical recess, where the contents can be dispensed from the open proximal end by rotating the cap axially.

2. The detachable measuring and dispensing cap for a portable container of claim 1, wherein the cylindrical body further comprises a receptacle for receiving a predetermined volume of contents, the receptacle disposed between the distal end of the cylindrical body and the aperture.

3. The detachable measuring and dispensing cap for a portable container of claim 2, wherein the receptacle is transparent such that contents contained in the receptacle can be seen through the cylindrical body.

4. The detachable measuring and dispensing cap for a portable container of claim 3, further comprising linear measurement markings for visually quantifying the volume of contents in the cylindrical body.

5. The detachable measuring and dispensing cap for a portable container of claim 1, further comprising an end cap detachably affixable to the open proximal end for sealing the open proximal end.

6. The detachable measuring and dispensing cap for a portable container of claim 5, wherein the end cap is tethered to the cylindrical body.

7. The detachable measuring and dispensing cap for a portable container of claim 1, wherein the closed distal end is closed with a detachable end cap.

8. The detachable measuring and dispensing cap for a portable container of claim 7, further comprising one or more receptacles of predetermined volume, the receptacle(s) attachable to the distal end of the cylindrical body in place of the detachable end cap.

9. The detachable measuring and dispensing cap for a portable container of claim 1, wherein the cylindrical body is between 1 centimeter and 100 centimeters in length and wherein the volume of the cylindrical recess is between 1 cubic centimeter and 200 cubic centimeters.

10. The detachable measuring and dispensing cap for a portable container of claim 1, wherein the open proximal end further comprises a one-way valve for preventing ambient air from flowing into the cylindrical body.

11. A detachable measuring and dispensing assembly for a handheld container comprising:
an elongated, tubular body, elongated along a lateral axis, the body comprising an open proximal end, the body defining a hollow interior channel of between 10 cubic millimeters and 1 cubic meter in volume, the body forming a recess, the recess penetrating the body to the channel;
a conduit affixed to the exterior of the cylindrical body, the conduit elongated along a longitudinal axis, the conduit defining a hollow interior passageway, the conduit enclosing the recess on the exterior of the body such that the channel and passageway are interconnected;
wherein the conduit comprises an open annular base with means for engaging a handheld container, such that contents of the handheld container, when the handheld container is inverted, flow from the handheld container, through the hollow passageway, into the channel, where the contents can be dispensed from the open proximal end by rotating the assembly axially.

12. The detachable measuring and dispensing device of claim 11, wherein the body is transparent such that contents contained in the recess are visible through the body.

13. The detachable measuring and dispensing device of claim 12, further comprising linear measurement markings for visually quantifying the amount of contents in the body.

14. The detachable measuring and dispensing device of claim 13, further comprising a cap screwable and detachably affixed to the open proximal end for sealing the open proximal end.

15. The detachable measuring and dispensing device of claim 8, wherein the open proximal end further comprises a valve for preventing ambient air from flowing into the body.

16. A detachable measuring and dispensing appendage for a handheld container comprising:
a T-shaped tubular body, having a hollow interior with an outlet opening, the T-shaped body comprising:
a lower member, having an inlet opening, the lower member having means for detachably engaging an outlet opening on the handheld container, the lower member defining a passageway interconnected with the hollow interior of the main body, the member oriented orthogonally to the main body; and
a hollow receptacle arm for receiving a predetermined volume of contents from the handheld container, the hollow receptacle arm interconnected with the hollow interior;
wherein the outlet opening is formed by an arm of the T-shaped body.

17. The detachable measuring and dispensing device of claim 16, further comprising one or more accessories for detachable affixation to the outlet opening from the list consisting of a funnel, a valve, a strainer, and a macerator.

18. The detachable measuring and dispensing device of claim 16, wherein the outlet opening comprises a valve for preventing ambient air from flowing into the body.

19. The detachable measuring and dispensing device of claim 16, further comprising a cap detachably affixable to the outlet opening for sealing the open outlet.

20. The detachable measuring and dispensing cap of claim 16, wherein the cap is tethered to the main body.
